(19) United States
(12) Patent Application Publication
(10) Pub. No.: US 2025/0164073 A1
(43) Pub. Date: May 22, 2025

(54) MEMBRANE TANK FEASIBLE FOR CRYOGENIC SERVICE

(71) Applicant: Lattice International AS, Billingstad (NO)

(72) Inventor: Pål G. BERGAN, Nesøya (NO)

(73) Assignee: Lattice International AS, Billingstad (NO)

(21) Appl. No.: 18/842,347

(22) PCT Filed: Mar. 3, 2023
(86) PCT No.: PCT/NO2023/050049

§ 371 Date: Aug. 28, 2024

(30) Foreign Application Priority Data
Mar. 3, 2022 (NO) 20220270

(51) Int. Cl. F17C 3/02; B63B 25/14

(52) U.S. Cl. CPC F17C 3/027; B63B 25/14; F17C 2201/0185; F17C 2203/0304; F17C 2203/0624; F17C 2203/0639; F17C 2209/232; F17C 2221/012; F17C 2221/017; F17C 2223/0161; F17C 2227/0142; F17C 2260/036; F17C 2270/0107

(57) ABSTRACT

Membrane tank for containment of fluids at temperature that can differ significantly from ambient temperature, for example for containing a cryogenic fluid, wherein the membrane tank comprises, in direction from an inner containment volume: a primary membrane that is fluid tight, facing the contained fluid in operation and functioning as the primary fluid barrier, an insulation layer, surrounding the membrane on the outside, an outer structure, such as a ship hull or bulkhead or other structure, wherein the outer structure supports the insulation layer and primary membrane inside and carries the resulting forces thereby, and at least one opening for loading and unloading of fluid, and an optional secondary membrane if the outer structure is a steel structure becoming brittle at cryogenic temperature, such as a ship hull outer structure, the secondary membrane dividing the insulation layer into an inner insulation between the primary and secondary membranes and an outer insulation between the secondary membrane and the outer structure, wherein the primary membrane comprises areas of flat, curved or double curved shape and a corrugation in between said areas, wherein said areas are fastened to the underlaying insulation and the corrugations are taking up thermally induced strain. The membrane tank is distinguished in that it further comprises a coupling part for connecting a vacuum pump operatively to the whole insulation layer or the inner insulation layer, for enabling vacuum in the whole insulation layer or the inner insulation layer, during loading, containment and unloading of cryogenic fluid.

### TECHNICAL FIELD

The present invention relates to a thermally insulated membrane tank placed inside a surrounding supporting structure for storage and transport of cold, very cold or hot fluids. More specifically, the invention provides a membrane tank particularly feasible for storage and transport of cryogenic fluids and a method for fabricating the tank.

### BACKGROUND ART

Storage and transport of cooled and cryogenic fluids are challenging, particularly at cryogenic temperature ranges. There exists a broad variety of gases or liquefied gases that are stored and transported at very low temperatures and are typically kept in insulated containments. One important example is Liquefied Natural Gas (LNG) which typically liquefies at −163° C. which is the “boiling point” at atmospheric pressure. Regardless type of fluid, all fluids that are gaseous at normal temperature and atmospheric pressure can be efficiently stored and transported as in liquid and gaseous form in containments during cooled and pressurized condition. Whereas it for some gases may be preferable to apply a combination of pressure and cooling, there are also cases where the gas is liquefied by cooling at atmospheric pressure and thereafter transferred and stored at such condition in the containments. LNG is an example of a liquified gas normally stored without applied pressure.

What happens with the stored, liquified gas principally follows two main paths: Any substance kept at temperature lower than the surroundings will receive some heat, thermally insulated or not. As a consequence, the liquified gas will start boiling with gas boil-off being released from the containment. Alternatively, the fluid transformed to gas is not allowed to escape from the containment while pressure and temperature will increase as a consequence. The first case is normally referred to as a “unpressurized” containment since the storage tank is not designed for substantial pressure build-up. Since climate damaging gases like LNG are very harmful when released to the atmosphere, and release may be prohibited by regulations, the gas boil-off may have to be burned, used in engines, or returned to the storage after being re-liquified. The second case requires the containment must be designed as a proper pressure vessel with strength capable of sustaining the pressure build-up during the anticipated maximum holding time for the gas inside.

The containment strategy chosen for a specific case depends on many factors such as type of gas, performance of thermal insulation and, the actual size of the tank. Small tanks have a larger surface-to-volume ratio than larger tanks; this means that the heat ingress problem will be much more severe for small tanks than for large tanks with the same type of insulation. Consequently, relatively small tanks, such as LNG fuel tanks on small ships, are likely to be built as pressure vessels capable of sustaining pressure build-up. On the other hand, very large tanks, such as land storage tanks for LNG and LNG transport ships, are normally designed for keeping the gas at atmospheric or near atmospheric pressure. The present invention primarily concerns unpressurized or low-pressure tanks.

There are essentially two main types of storage tanks for liquified gas under atmospheric pressure; those are shell type tanks and membrane tanks. Shell tanks are normally prismatic or spherical in shape with thermal insulation on the outside. These tanks are independent from the outer structure and often called the independent tanks because they are designed to withstand all the loads from the stored fluids, which can be vapor pressure, static hydraulic pressure, and ship motion-induced dynamic pressure. This is why these tanks are much heavier than the membrane tanks. The other insulated type of tank, membrane tanks, depend on being supported by a load-bearing, outer structure, such as a cargo room in a ship, or a silo type structure on land. The reason for this is that the barrier against the cold, liquified gas is only a thin and rather weak membrane with thermal insulation that depend on being supported by the outer loadbearing structure via an intermediate layer of insulation. Clearly, the membrane will take on the same temperature as the cold fluid inside the tank and, consequently, contract significantly from the original state at room temperature because of cooling. Thus, since the surrounding support structure is not cooled and it is much stiffer and stronger than the membrane, the membrane alone will have to deal with the thermal contraction problem. This could potentially overstress and break the membrane with leakage as consequence. The way of dealing with the thermal contraction of a membrane is to provide deformational flexibility in the plane of the membrane. This can be done by shaping the membrane plate with geometric corrugations patterns in two perpendicular directions such that in-plane thermal strains can be compensated by bending and stretching of the corrugations while planar parts of the membrane can contract and remain flat without being severely stressed. As recognized by many, development of effective corrugation geometries that secure acceptable stresses in the membrane is no simple matter. Corrugation geometries employed by industry so far have to a large extent been based on experience and testing while the evidence of securing low stress levels has been less clear. In all cases it is a particular challenge to obtain sufficient deformability and acceptable stress levels at the locations where corrugation channels in different directions intersect.

Along with sustained thermal stressing, variable pressure loading from the internal fluid can also be a problem for the integrity and sustainability of the membrane. For liquefied gas membrane tanks onboard ocean going ships the ship motion will generate internal liquid surface waves within the tank which can result in severe cyclic loading on the membrane, cracking, and leakage failure.

This problem is particularly associated with high stress concentrations in the beforementioned corrugations. Moreover, severe surface motion, often referred to as sloshing, can lead to very high, local dynamic pressures when such waves hit walls and internal corners of the tank. These problems are recognized as a specific challenge for membrane tanks, and through the years, there have been cases requiring long off-time and costly repair of damage.

Thermally insulated membrane tanks for LNG have been used in the gas and shipping industries for more than 60 years and much experience has been gained during this time. There has also been a remarkable growth in the size of membrane tanks used onboard LNG carrying ships. Single tank capacities for ships and floating terminals may be more than 50000 m³ (several hundred thousand m³ for a series of tanks onboard) whereas single land tanks may have the size of several hundred thousand m³.

However, a demand still exists for providing membrane tanks for storage of cryogenic fluids such as LNG and even LH2 (liquid hydrogen), cold fluids or warm fluids, relative to ambient temperature, with a combination of increased safety and reduced cost. Cryogenic fluid is usually defined as fluid with boiling point at −90° C. or lower at atmospheric pressure. The objective of the invention is to provide a membrane tank and a method with beneficial effects on safety, versatility and/or cost.

Searching has not revealed any publication with description or illustrations of a membrane tank as provided by the present invention. The nearest publications, describing and illustrating the current state of the art in the technical field, apparently are: US4,149,652A, DE2251688B2, KR20210152835A, US4,119,241A, EP 1732828, KR100213686B1, WO 2021037483 A1, US 20,202,56514 A1, US2018073678 A1 and KR 20160087652 A. None of said publications includes description or illustrations of a membrane tank with fully scalable vacuum insulation. And none of said publications includes description or illustrations of corrugations having shape, as seen in cross section, of a cosine function or a natural buckling function, or why such shape is beneficial.

### SUMMARY OF INVENTION

The invention provides a membrane tank for containment of fluids at temperature that can differ significantly from ambient temperature, for example for containing a cryogenic fluid, wherein the membrane tank comprises, in direction from an inner containment volume:
a primary membrane that is fluid tight, facing the contained fluid in operation and functioning as the primary fluid barrier,
an insulation layer, surrounding the membrane on the outside,
an outer structure, such as a ship hull or bulkhead or other structure, wherein the outer structure supports the insulation layer and primary membrane inside and carries the resulting forces thereby, and
at least one opening for loading and unloading of fluid, and
an optional secondary membrane if the outer structure is a steel structure or other structure becoming brittle at cryogenic temperature, such as a ship hull outer structure, the secondary membrane dividing the insulation layer into an inner insulation between the primary and secondary membranes and an outer insulation between the secondary membrane and the outer structure,

wherein the primary membrane comprises areas of flat, curved or double curved shape and a corrugation in between said areas, wherein said areas are fastened to the underlaying insulation and the corrugations are taking up thermally induced strain and to some extent deformations caused by hydrostatic and dynamic loads.

The membrane tank is distinguished in that it further comprises a coupling part for connecting a vacuum pump operatively to the whole insulation layer or the inner insulation layer, for enabling vacuum in the whole insulation layer or the inner insulation layer, during loading, containment and unloading of cryogenic fluid.

For clarity, cryogenic fluid is used as an example of how the tank membrane behaves, specifically how the corrugations are stretched, upon filling the cryogenic fluid. A most preferable corrugation shape, as seen in cross section, of a cosine function or a natural buckling function, refers to said shape at ambient temperature. The colder the fluid compared to ambient temperature, the more thermal contraction of the areas of flat, curved, or doubly curved areas, and the more stretching of the corrugations. If a warmer fluid than ambient temperature is filled into the tank, the deformations will be opposite, in that the flat, curved and double curved areas will expand, and the corrugations will be compressed. The present invention provides membrane tank embodiments for cold or cryogenic fluid storage, with membrane stretching as described, and membrane tank embodiments for warm fluid storage, with opposite deformation, with compression of the corrugations. Some membrane tank embodiments of the invention are for containing cold or warm fluid. In each embodiment of the invention, with cold, cryogenic, or warm fluid containment relative to ambient temperature, the corrugations have a shape, as seen in cross section, of a cosine function or a buckling function, wherein a minimum or near minimum of elastic energy is stored in the corrugations by said stretching, or compressing, and a minimum or near minimum of stress is resulting in the corrugations by said stretching or compressing. This will be clearly described below and illustrated in figures.

The technical effects of the invention are many, as will be described below. The two most significant technical effects are that the novel membrane geometry provides corrugations and intersections between corrugations which are formed by less plastic straining and result in significantly lower thermally induced stresses and better long-term structural integrity. This offers numerous technical benefits, wherein one is to enable larger distance between corrugations and thereby attain more efficient fabrication and installation, as well as lower cost. For example, while a typical distance between corrugations is 0.2-0.5 m between corrugations in tanks for LNG, the distance between corrugations for the tanks of the invention, using similar or identical membrane material and for LNG, easily can exceed 1 m, which is significantly longer distance between corrugations compared to state of the art. This results in fewer corrugations, fewer crossings of corrugations, less welding or other joining, fewer sources of failure, facilitated production and reduced cost. A major achievement with the invention is that many membrane tank embodiments are feasible for liquid hydrogen containment, LH2, or even liquid helium containment, which so far apparently is not existing or possible with current membrane tank technology. Even for membrane tanks for LH2 containment, the distance between corrugations may exceed 1 m.

Preferably, the corrugations, as seen in cross section at ambient temperature without thermal induced strain, have shape in accordance with geometric functions consistent with buckling of the membrane over the corrugation spans when subjected to uniform compression in two directions within the plane of the membrane or/and shape as defined by cosine functions, wherein the shape is exact or within an acceptable deviation. The technical effect of the invention is clear from the description above and below. Geometric deviations from exact cosine function shape or buckling function shape of corrugations as seen in cross-section, are allowable up to the extent the technical effect over state-of the art membrane tanks still is present. Preferably, the shape is exact or within an acceptable geometric deviation of less than 5%, 3%, 2% or 1% from a perfect cosine function or buckling function amplitude at any point.

Preferably, the shape of crossing corrugations complies with a superimposed shape of the corrugations crossing.

The membrane tank preferably is further comprising an intermediate membrane that is fluid tight, dividing the insulation into two insulation layers, each of which can be circulated by inert gas for leak detection or evacuated to avoid air condensation and/or solidification for liquid hydrogen or helium storage.

The membrane tank preferably is comprising membrane sections with corrugations, formed by die pressing or otherwise, with section sides at maximum distance from corrugation crossings, preferably with sides perpendicular to corrugations extending out through the sides, possibly the membrane is stress relief treated before welding into a complete fluid tight membrane, wherein the stress level of the membrane is minimized.

The membrane tank preferably is comprising blocks of insulation in the insulation layer, wherein the blocks match the dimensions and shape of the flat, curved or double curved primary membrane areas inside and preferably is covered by primary membrane sections with corrugations and crossing corrugations over or inside where insulation blocks are joined, with insulation block joints crossings under corrugation crossings at or near centre of primary membrane sections, wherein the blocks are arranged side by side, wherein the blocks as arranged at ambient temperature preferably are contacting for tanks for cryogenic or cold fluid containment, preferably with tongue and notch for reducing thermal radiation when cooled down but preferably with a gap Δe or Δf in between the blocks for warm fluid containment. Thereby, the strain and stress are reduced while the building is facilitated.

The invention also provides a method of building a membrane tank according to the invention, comprising the steps:
to build an insulation layer, wherein the insulation layer is arranged on an inner side of an outer structure, such as a ship hull or bulkhead or other loadbearing structure on land or at sea to surround the insulation on the outside,
to build or arrange at least one opening for loading and unloading of fluid,
to build and arrange a primary membrane that is fluid tight on the insulation surface, wherein the outer structure supports the inside insulation and primary membrane and carries the resulting forces thereby, and the membrane is containing for example a cryogenic fluid, wherein the membrane comprises areas of flat, curved or double curved shape, said areas are fastened to the underlaying insulation, the membrane further comprising a corrugation in between said areas for taking up thermally induced strain and any deformations caused by hydrostatic and dynamic loads. The method is distinguished in that it further comprises to arrange a coupling part for connecting a vacuum pump operatively to the insulation layer, for enabling vacuum in the insulation layer, between the primary membrane and the outer structure or between the primary membrane and an optional secondary membrane, during loading, containment and unloading of cryogenic fluid or other fluid.

According to the method, the tank is built layer by layer and/or is built block by block with blocks comprising all or some of the insulation and membrane structures required, whereby the blocks are finalized if required, arranged and joined on the site in the membrane tank.

Preferably, the primary membrane is formed as plate sections that are joined by welding or otherwise methods to complete the continuous membrane, wherein crossing corrugations are at the centre and/or within the sides of the plate sections, such that plate sections are joined preferably at maximum distance from crossing corrugations, and the corrugations are preferably formed by plastic die pressing or similar forming operations, preferably with sides perpendicular to corrugations extending out through the sides, preferably the stress in the membrane is relieved by post heat treatment such as annealing before welding or joining otherwise into a complete fluid tight membrane, wherein the stress level of the membrane is minimized.

The invention also provides use of the membrane tank of the invention, for storage and/or transport of fluid having temperature different from ambient temperature, such as cryogenic fluid such as LH2, LHe, LO2, LN2, LNG, LPG, ammonia, carbon dioxide, other cold fluid, or warm fluid.

The membrane tank preferably is comprising that:
the membrane is comprised of a thin plate material having mechanical and chemical properties suited for the purpose considering the properties of the fluid and the pressure exerted from the fluid in the tank,
the membrane has geometric corrugation of a special geometry suitable for sustaining significant thermal deformations further described in the following,
plate sections between the corrugations may be flat, singly curved, or doubly curved as may be required to provide an enclosed, leakage tight containment solution fitting the geometry of the external supporting structure,
the membrane has a geometry that enables a simple way of manufacturing by plastic forming or stamping of a flat plate or by casting,
the membrane is attached to the surrounding insulation layer by suitable mechanical or adhesive means,
the thermal insulation layer comprises insulation layers, insulation block layers or insulation box elements that enable good thermal insulation as well as significant deformational differences between the membrane and the outer supporting structure, and has sufficient mechanical strength to carry actual pressure loads either directly or by strengthening means such as fiber reinforcement or load carrying boxes of plates therein,
the thermal insulation layer may comprise sublayers with fluid tight membrane in between to ensure extra leak tightness in compliance with applicable rule requirements
the outer supporting structure has sufficient stiffness and strength
capable of carry in all loads from the inner membrane tank and can in principle be of any shape and form suitable for the specific purpose
much reduced or no loss of cargo due to boil-off, contrary to most other membrane tank designs
in most cases less need for cooling and condensing boiled off cargo for recirculating cargo, due to enhanced insulation performance
ability to store liquid gases, such as liquid hydrogen and helium, at temperatures lower than the condensation temperature of air

The thickness of the membrane plate depends on the material from which it is made, pressure on static and dynamic pressure exerted from the fluid contained in the tank, thermal stress and strain, and the effect of plate thickness on the deformability and plastic straining during the initial forming of the corrugations. Typical plate thickness in consideration of this may be from 0.2 to 4 mm. The membrane plate material must be of type suited for the operation temperatures to which it is exposed; for instance, cryogenic temperatures require special steel or aluminum alloys that remain ductile during very low temperatures. Examples of liquified gases are natural gas with storage temperature of about −163° C. and liquid hydrogen with −253° C. at atmospheric pressure. Moreover, the membrane material must be resistant to degradation caused by chemical or electrochemical interaction with the fluid inside the tank. In addition to membranes made of metal plates, corrugated membranes may be made of non-metallic materials such as plastic or composites. In such case the membrane may be cast directly with corrugations of the type defined for the invention rather making the corrugations by plastic forming.

A distinguishing feature of the membrane tanks of the invention, is a corrugation geometry that allows for significant thermal contraction or expansion of the membrane without resulting in overstressing of the membrane. A further distinguishing feature of the membrane tanks of the invention is to be able to achieve this goal even if the distance between corrugations is longer than what is commonly used or possible for membrane tanks provided by the industry today.

A main target by corrugations is to provide flexibility in the plane of the membrane to compensate for in-plane thermal contraction/expansion and, since thermal straining of an isotropic material is the same in all directions, the required flexibility can be achieved by a regular, checkered pattern of corrugations. The corrugations can rather simply be made with some form of channel-type geometry; however, the main problem arises at the intersections or crossing of corrugation channels since straight, intersecting continuations of the channel geometry through the intersections imply that the deformation will be fully “locked” at the point of crossing. FIG. 1 illustrates an example of membrane tank corrugations commonly used by the industry today, particularly in connection with large membrane tanks for storage of liquefied natural gas (LNG). In this case the channel heights in the two directions are different;

locking against flexibility is achieved by significant bending and folding of the channels at their intersections. Although such corrugation geometries are widely in use there are some significant concerns regarding their performance. The highly folded plate geometry implies very severe plastic straining during the initial, plastic forming. Moreover, the sharp intersection folds also represent very stiff local zones and stress concentrations, such zones are often referred to as “hot spots”. Along with concerns regarding high thermal stresses at such points, an additional problem can be that such points are particularly prone to fatigue during cyclic stressing as may occur both from thermal variations and from variable pressure caused dynamic fluid motion within the tank. The current invention provides a way of achieving high in-plane flexibility without high, local stress concentrations within the corrugation channels and, most importantly, at the intersection zones between corrugations. The invention is basing the channel and intersection geometry on utilizing the concept of minimum potential energy to derive a natural “buckling pattern” that a thin plate naturally will adopt when pressed together across a checkered pattern of free spans. Notably the natural, elastic buckling pattern represents the geometric shape that results in the least stored elastic energy during a forced, uniform contraction in the two directions of the membrane. This also ensures lowest possible stresses and smooth distribution of stresses. Further details about how geometric shapes according to the invention can be generated will be explained in the following.

As explained, the membrane consists of a crossing pattern of corrugations as well as membrane sections in between the distinct corrugations. In the simplest case, flat corrugated membranes can fit flat floor, wall, and ceiling zones of a tank. Tanks with prismatic shape will inevitably have corner lines and pointed corners. This problem can be dealt with by the present invention by shaping the membrane sections between the corrugations with consistently cylindrical or spherical geometry. Likewise, when the outer supporting structure has cylindrical shape, as itself being cylindrical, the primary corrugated membrane can be made with sections between corrugations that are correspondingly cylindrical. The joining areas between a cylindrical tank wall and the floor or roof sections can similarly be shaped such that the sections between corrugations are made with curved or doubly curved shape. Circular floor or ceiling zones can be fit with crossing patterns of corrugations.

The smooth shape of the membrane corrugations of the invention provides significant advantages in production as compared with corrugated membranes most frequently used today. In particular, the fact that there are no doubly folding geometry and no very high plastic straining simplifies production of the corrugations very much and reduces requirements to ductility of the membrane material. The manufacturing of the corrugation may thus largely be based on stamping out the corrugation pattern while the flat parts between corrugations are restrained out-of-plane to remain flat while allowing for in-plane motion to avoid unwanted stretching and thinning of the membrane during forming. The press forming or stamping out of corrugations and crossing corrugations is facilitated by the cosine or buckling shape, since no double folding exists and no sharp corners. Accordingly, the corrugations and crossing corrugations are conical and slip easily out of the forming machines and the shapes minimize strain also during forming, not only during operation for containing cryogenic fluid.

It is imperative that the membrane provides a leak-tight barrier which fully surrounds the stored fluid inside the tank. This means that the membrane must provide a complete enclosure with bottom, side walls and roof. It is important that the membrane does not come loose from the layer of insulation since dynamic pressures, gravitational forces and deformational stresses could cause detachment and damage to the membrane. Chosen means of attachment depends largely on the type of materials used for the membrane and the insulation layer. In some cases, it may be sufficient to employ some suitable means of adhesive gluing. However, mechanical means of connecting the membrane with the insulation may also be preferable. Such means may include weld attachments, locking devices, anchoring bolts or anchor pins and the like depending on the outer structural layer of the insulation and the actual consistency of the thermal insulation. The membrane will normally have openings for various types of piping, instrumentation and possibly also manhole access. Such connections may be located within a tank dome. In any case, all such openings in the membrane must be leak tight and designed in a way that accounts for thermal deformations.

It is an objective of the invention to be applicable for many types of thermal insulation on the outside of the membrane. Although use of thermal insulation is a part of the invention it is not limited to specific designs of such insulation.

Much used solutions with reinforced insulation systems including porous particles such as perlite, fiber and foam type insulation materials, with or without strengthening fibers, are thus applicable with the invention. This also includes systems where the insulation systems comprise box elements with reinforcing plating such as plywood type structures or glass fiber reinforced plating.

The membrane that is fluid tight and containing the fluid stored is made with material that is suited for the range of temperatures to which it is exposed and have sufficient deformability, examples are austenitic stainless steel such as AISI 304 or −304L, other austenitic stainless steel, or nickel austenitic steel alloy. Good proven weldability combined with lower cost can be preferred over low thermal coefficient of expansion, for example stainless steel AISI 304L or −304.

The international gas code requires secondary leakage barriers to be included for membrane tanks to protect the external, load bearing structure, such as a cargo room in a ship, against leakage of cryogenic fluid in case of leakage of cryogenic fluid through the primary membrane. Various solutions are available for the secondary membrane such as corrugated membranes, flat membranes made of temperature insensitive invar (34 percent Ni), or single- or double-layer flexible membranes made of composite material with woven fiber fabric such as for “Triplex”. A further alternative will be to use corrugated membranes formed according to the geometry defined by the current invention. As the secondary membrane is normally subjected to less loading and straining the amplitude of corrugations may be less and the thickness of the membrane may be thinner than for the primary membrane.

It is recognized that vacuum that is essentially void of air or other gases provides excellent thermal insulation. The main embodiment of the invention provides use of vacuum insulation in connection with membrane tank by using leak tight membranes of the current type both for the primary and secondary membranes and evacuation of air within the layer in between. By vacuum is here meant that internal gas, typically air, is pumped out to an extent practically feasible implying extremely low internal pressure and near vacuum condition, for example 0,01, 0.001 or 0,0001 atmosphere or lower. In such case the space between the two membrane layers shall be filled with a supporting, porous or fibrous layer that has sufficient structural strength to carry the pressure from the fluid, including atmospheric overpressure from outside the vacuum layer. This layer should be suitable for vacuuming by pumping out the air trapped within the layer. Additional insulation may be used external to the secondary membrane. An interesting application by this solution is that the membrane tank may be used for storing fluids at extremely low temperatures, such as liquid hydrogen and liquid helium. For membrane tanks of the invention for storage of liquid hydrogen or liquid helium, the temperature difference created by the vacuum layer must be larger than the temperature difference between that of the stored fluid and the condensation temperature of air. The insulation on the outside of the secondary membrane may be of conventional, air-filled type and have sufficient strength as well as thickness to ensure adequate insulation against the outside air or supporting structure or could possibly or preferably also be vacuum insulation.

An objective of the invention is to provide membrane tank solutions for the widest possible range of applications, including fuel and cargo tanks for cryogenic fluids placed inside ships, platforms, for land storage, and underground storage. The design of actual supporting structure must be such that it can carry the weight of the fluid stored in the tank, the weight of the insulation system and static and dynamic pressures transferred from the fluid inside the tank. Versatility of the design of the supporting structure is an integral part of the invention, and the invention can be used with most types of structural external tank solutions.

The invention also provides a membrane tank for containment of fluids at temperature that can differ significantly from ambient temperature, for example for containing a cryogenic fluid, wherein the membrane tank comprises, in direction from an inner containment volume:
a primary membrane that is fluid tight, facing the contained fluid in operation and functioning as the primary fluid barrier,
an insulation layer, surrounding the membrane on the outside,
an outer structure, such as a ship hull or bulkhead or other structure, wherein the outer structure supports the insulation layer and primary membrane inside and carries the resulting forces thereby, and
at least one opening for loading and unloading of fluid, and
an optional secondary membrane if the outer structure is a steel structure becoming brittle at cryogenic temperature, such as a ship hull outer structure, the secondary membrane dividing the insulation layer into an inner insulation between the primary and secondary membranes and an outer insulation between the secondary membrane and the outer structure,

wherein the primary membrane comprises areas of flat, curved or double curved shape and a corrugation in between said areas, wherein said areas are fastened to the underlaying insulation and the corrugations are taking up thermally induced strain, wherein the membrane tank is distinguished in that the corrugations have a shape, as seen in cross section, of a cosine function or a natural buckling function, resulting in that a minimum of elastic energy is stored in the corrugations by thermally induced contraction when cooling down the tank upon loading cryogenic fluid, resulting in only elastic stresses in the corrugations by said thermal contraction,
and preferably, the shape of crossing corrugations complies with a superimposed shape of the corrugations, without sharp bends or corners and without double folding, enabling simple die forming, and preferably, the shape is exact or within an acceptable geometric deviation of less than 5%, 3%, 2% or 1% from a perfect cosine function or buckling function amplitude at any point, and preferably, wherein the actual stretching Δe and Δf upon cooling of the membrane by ΔT, with initial corrugation spans e and f at ambient temperature, wherein c and d are dimensions between the respective corrugations, are as follows:

$$Δ e = {e}_{T} - e = c - {c}_{T} = - c αΔ T , and Δ f = {f}_{T} - f = - d αΔ T \qquad ( 3 )$$

wherein α is the secant modulus (coefficient) of thermal expansion for the membrane,
and preferably, the membrane tank is comprising blocks of insulation in the insulation layer, wherein the blocks match the dimensions and shape of the flat, curved or double curved primary membrane areas inside and preferably is covered by primary membrane sections with corrugations and crossing corrugations over or inside where insulation blocks are joined, with insulation block joints crossings under corrugation crossings at or near centre of primary membrane sections, wherein the blocks are arranged side by side, wherein the blocks as arranged at ambient temperature preferably are contacting for tanks for cryogenic or cold fluid containment, preferably with tongue and notch for reducing thermal radiation when cooled down but preferably with a gap Δe or Δf in between the blocks for warm fluid containment.

The invention also provides a method of building a membrane tank according to the invention, comprising the steps:
to build an insulation layer, wherein the insulation layer is arranged on an inner side of an outer structure, such as a ship hull or bulkhead or other loadbearing structure on land or at sea to surround the insulation on the outside,
to build or arrange at least one opening for loading and unloading of fluid,
to build and arrange a primary membrane that is fluid tight on the insulation surface, wherein the outer structure supports the inside insulation and primary membrane and carries the resulting forces thereby, and the membrane is containing for example a cryogenic fluid, wherein the membrane comprises areas of flat, curved or double curved shape, said areas are fastened to the underlaying insulation, the membrane further comprising a corrugation in between said areas for taking up thermally induced strain, distinguished in that the membrane is shaped with corrugations in between areas of flat, curved or double curved shape, said areas are fastened to the underlaying insulation, wherein the corrugations have a shape, as seen in cross section, of a cosine function or a buckling function, wherein a minimum of elastic energy is stored in the corrugations during forming as well as by thermally induced stretching of the corrugation when cooling down the tank upon loading cryogenic fluid, resulting in a minimum of stress in the corrugations by said stretching, and
preferably the membrane tank is built so that it is comprising blocks of insulation in the insulation layer, wherein the blocks match the dimensions and shape of the flat, curved or double curved primary membrane areas inside and preferably is covered by primary membrane sections with corrugations and crossing corrugations over or inside where insulation blocks are joined, with insulation block joints crossings under corrugation crossings at or near centre of primary membrane sections, wherein the blocks are arranged side by side, wherein the blocks as arranged at ambient temperature preferably are contacting for tanks for cryogenic or cold fluid containment, preferably with tongue and notch for reducing thermal radiation when cooled down but preferably with a gap Δe or Δf in between the blocks for warm fluid containment. Reduced stress and strain and facilitated building are the results.

Typical membrane tanks of the invention are tanks for transport of LH2, LNG and other cryogenic or cold liquids, in ships, wherein the ship hull structure and possibly further internal structure such as bulkheads are the outer loadbearing structure. Other typical membrane tanks of the invention are stationary storage tanks, such as concrete tanks or metal tanks standing on ground or buried in ground or arranged underground such as in caves, wherein the concrete, metal, other structure or the surrounding cave structure is or is part of the outer loadbearing structure. For many preferable embodiments of the membrane tank, the insulation comprises foam with open pores, such as PU-polyurethane, that is strong and good for vacuuming at the same time, preferably shaped as blocks, preferably with grooves facing the primary membranes forming channels for easier vacuuming as installed.

### BRIEF DESCRIPTION OF DRAWINGS

FIG. 1 illustrates a corrugation pattern, not according to the present invention, used in many current thermally insulated membrane tanks

FIG. 2 illustrates a membrane cargo tank inside the hull of a ship

FIG. 3 illustrates a membrane tank according to the present invention, with outward and inward corrugation and two layers of insulation

FIG. 4 illustrates a membrane tank according to the present invention, with one layer of vacuum insulation and one layer of conventional thermal insulation

FIG. 5 illustrates thermal contraction a membrane layer where the deformations primarily is dealt with by a grid of corrugations

FIG. 6 illustrates the principle of generating a low energy corrugation geometry without major stress concentrations

FIG. 7 illustrates further extension of low energy membrane geometry for crossing of corrugations

FIG. 8 illustrates how the membrane geometry at crossing of corrugations can be derived by use of computer simulations

FIG. 9 shows an example of membrane corrugation geometry generated by computer simulation and computer graphics

FIG. 10 gives some examples of adaptation of the invention to different tank geometries

FIG. 11 illustrates how membrane sections with multiple corrugations may be fabricated

### DETAILED DESCRIPTION OF THE INVENTION

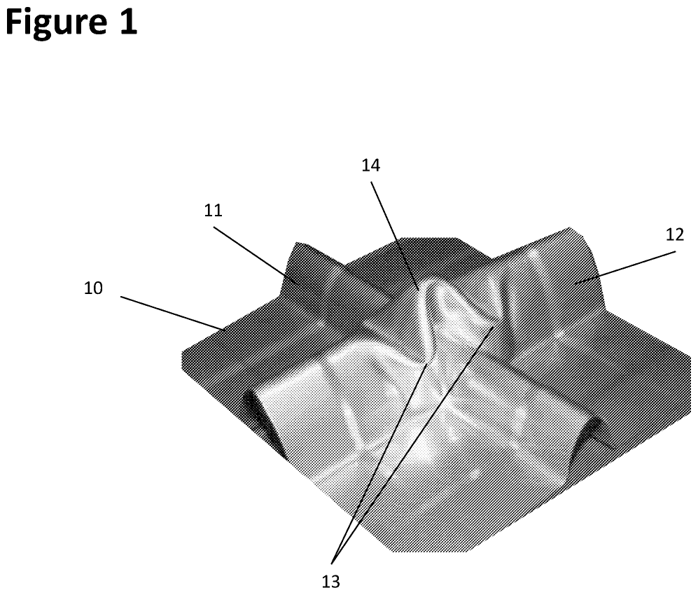

The problem with thermal contraction or expansion within multi-barrier insulation systems is often dealt with using some form of geometric corrugation by which a flexible membrane barrier allows for the deformations arising from temperatures changes at the different sides of the insulation. A typical example of dealing with different thermal conditions and deformations is the design currently used for thermally insulated tanks for storage of cooled or cryogenic fluids such as liquefied natural gas (LNG). In the case of membrane type cargo tanks for carrying LNG onboard ships it is the ship structure itself that provides the load bearing support structure whereas the cryogenic fluid is kept insulated and separated from this structure by a layer of thermal insulation with sufficient thermal insulation capacity and strength and a leak-tight membrane against the internal fluid. Regulations may also require secondary, leak-tight barriers inside the insulation layer for safety reasons. A basic problem arises when the membrane barrier against the cold fluid thermally contracts significantly whereas the tank structure, as part of the ship, does not contract. With major thermal contraction a flat membrane would clearly break or come loose due to thermal contraction and straining. This problem is normally dealt with by providing the initially flat membrane with geometric corrugations in order that the corrugation zones compensate for the contraction through bending and stretching of the corrugations. What makes this problem difficult is that the thermal contraction naturally takes place in both directions of the membrane which requires that the corrugations also must be oriented in two directions that usually will be normal to each other. Consequently, the grid of corrugations includes crossing of corrugations. This necessitates that the corrugations cannot continue uninterrupted through the crossings, but have to be “broken” at these intersections to fully enable two-dimensional contraction. FIG. 1 shows a typical example of how the corrugation intersection problem has been resolved by current art. In addition to the basic membrane plane 10 there is corrugation channel 11 in one direction and a somewhat larger corrugation channel 12 in the perpendicular direction. The “breaking” of the intersecting corrugations is done by creating folds or “knots” 13 and 14 normal to the length direction of the two corrugations in order that each corrugation also can contract in their own length direction. It is seen that the corrugations have multiple rather sharp bends which implies significant local plastic straining during geometric forming of the corrugation pattern. Clearly, additional thermally generated stresses will arise during operation caused by the actual thermal contraction of the membrane. The double channel geometry with doubly folded knots implies very stiff structural zones which typically will give rise to strong stress concentrations or “hot spots”; these stress concentrations can cause exceedingly high stresses beyond normally accepted stress levels for the specific material used in the membrane. The current invention is based on a principle which minimizes deformational energy stored during thermal contraction and thereby defines a significantly different type of corrugation and intersection geometry which strongly reduces elastic and any plastic strain during cooling or heating, and/or the current invention is based on fully scalable vacuum insulation. This has also beneficial consequences regarding fatigue damage during thermal or mechanical cycling.

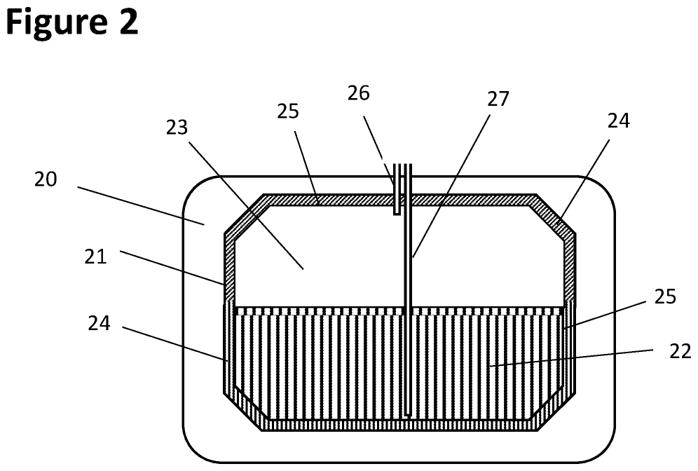

FIG. 2 illustrates the general principle of a membrane tank. Since a membrane has nearly no structural strength by itself, the membrane must be supported by a load-carrying containment structure that carries all static and dynamic pressures from the liquid phase fluid and the gaseous phase fluid transferred from the fluid inside the tank. In FIG. 2 this is illustrated for a cargo tank inside a ship where the ship hull 20 with the cargo hold 21 provides a complete and sufficiently strong tank enclosure to withstand the pressures from the fluid in form of liquid 22 and gas 23. Given that the tank should be capable of holding a fluid with temperature completely different from the surrounding structure, this being very hot or highly refrigerated fluid, it is necessary to separate the fluid from the enclosing structure with an adequate layer of thermal insulation 24. Clearly, the fluid must be contained within a leak-proof barrier which is here a relatively thin and flexible membrane 25. Thus, the membrane 25 is the primary barrier against the contained fluid and it takes on the temperature of the contained fluid. Further reference to types of insulation and properties of the membrane will be given later. The figure also indicates openings with piping 26 and 27 extending to the outside serving the purpose of filling and emptying of the tank. The tank will normally include openings for human access for inspection as well as for various forms of cabling for monitoring, instrumentation, and internal pumps. The tank in the figure reflects a typical shape of a membrane tank inside a ship, such as for LNG cargo tanks.

However, the supporting structure for a membrane tank of the invention may also have a very different shape, such as a cylindrical or box-like form, and be positioned on offshore structure or on land. The membrane tank of the invention applies equally well for such cases.

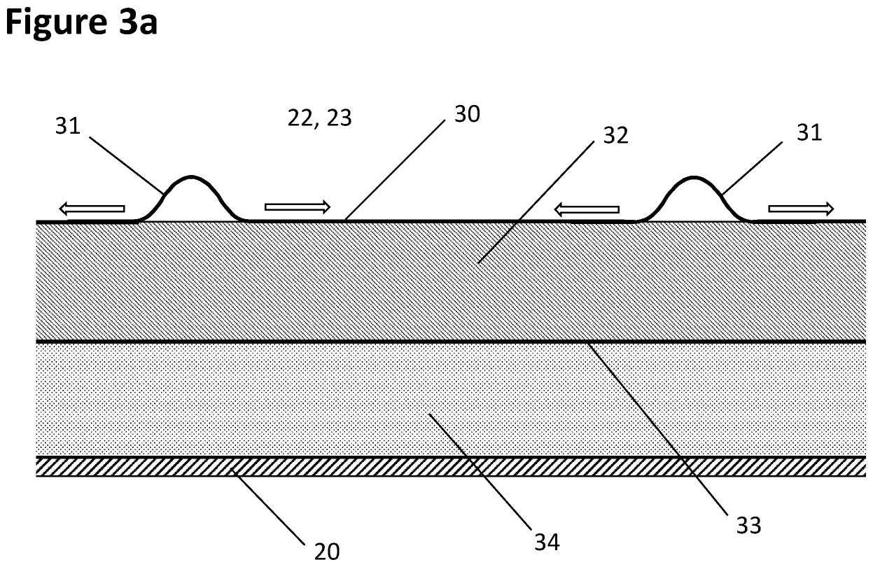

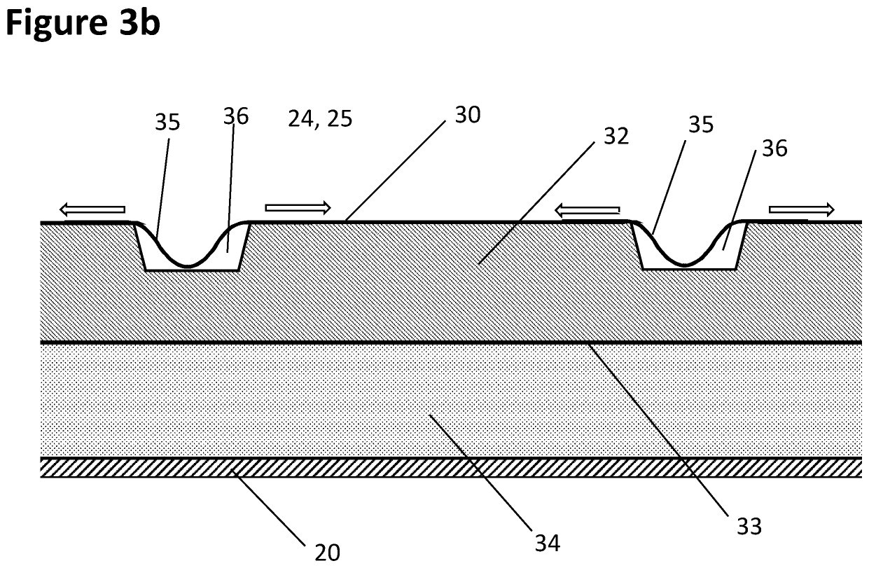

FIG. 3a shows in further detail the primary membrane layer of the invention with insulation. Here the membrane 25 is characterized by smooth parts 30 that are fully connected with the under-laying insulation and, accordingly, are flat, cylindrical, or doubly curved as in rounded corners, depending on the geometry of the outer tank 21. Assuming that the fluid is highly cooled, the membrane sections will contract in accordance with the differential temperature between manufacturing temperature of the installed membrane and the temperature of the stored fluid during operation; such contraction is illustrated by the double arrows in the figure. A continuously smooth membrane could easily break since the stiff, outer load-bearing structure will fully resist contraction and thermal strains in the constrained membrane will have to be dealt with by the membrane itself without breaking the membrane and possibly also lead to other forms of damage such as delamination and separation. The way of dealing with this problem is to shape the membrane with discrete, bent corrugations as illustrated with the protruding sections 31. The contraction of the smooth sections 30 can thus be dealt with by stretching and bending of the corrugations 31. It is preferable that the membrane is thin to keep the bending stresses in the corrugations at an acceptable low level. Still, the thickness of the membrane must be sufficiently thick to sustain the fluid pressure onto the free spanning corrugation.

The figure also shows that thermal insulation may consist of two layers, a primary insulation layer 32 and a secondary insulation layer 34 separated by a secondary, leak-tight membrane 33. The main insulation materials used for the insulation layers are normally insulation foam, such as polyurethane foam, with or without additional fiber reinforcement. Weaker types of insulation materials, such as fibrous insulation and perlite pebbles, may also be used. It may thus be necessary to strengthen the insulation layers with box-like load carrying elements made of plywood or other suitable strengthening materials for transferring the pressure from the fluid inside the tank to the supporting structure 20, 21. Technical solutions for the insulation layers are known from existing industrial practice and readily available.

The secondary membrane 33 is a safety measure to protect the surrounding structure 20 against being exposed to very cold fluid in case there is a leakage through the primary membrane 30. Having a secondary membrane is a safety measure which is typically required by the codes for LNG membrane tanks. The figure shows a secondary membrane without corrugations; this can be made of a material that is insensitive to thermal contraction and thus does not contract, such as the steel-nickel alloy invar. Alternatively, the membrane itself is made of some form of woven material, such as Triplex membrane, that has sufficient elasticity as the same time as being leak-proof. As will be shown later, the secondary membrane can also be made with corrugations like the primary membrane. The primary membrane must be attached to the insulation layers to keep it position. There are various ways of doing this such as by various forms of mechanical attachments which can also include gluing. http://www.ivt.ninu.no/epl/fag/lep4215/innhold/LNG%20Conferences/2007/fsco mmand/PO11YLee s.pdf

FIG. 3b shows an alternative where the corrugations of the invention 35 are being directed into the insulation rather than into the tank. The corrugations of this embodiment can equally well accommodate thermal contraction by bending and stretching in the corrugations, the difference is that the fluid pressure acts on a “suspension” type geometry rather than an “arch” type geometry. It is also seen from the figure that the primary insulation layer has grooves 36 to accommodate for that the corrugations go into the insulation layer. When choosing between the alternatives shown in FIGS. 3a and 3b a consideration may be that it is easier to weld together sections and corrugations of the type 3a compared with corrugations bending into the insulation layer.

It is an objective by the present innovation to be applicable with different types of thermal insulation systems. One alternative type of insulation is vacuum insulation which is based on the principle that the air or gas in the vacuum insulation layer is evacuated to a very large extent, such as a small fraction of atmospheric pressure; thereby effectively reducing heat transfer by conduction and convection through the layer. It is also significant that vacuum insulation is the only practical type of insulation for storing liquid hydrogen at −253° C. (20 degrees K) since porous or fibrous insulation filled with air or other gas will quickly liquefy and even solidify at such temperatures, thereby making the insulation layer lose its thermal insulation capability.

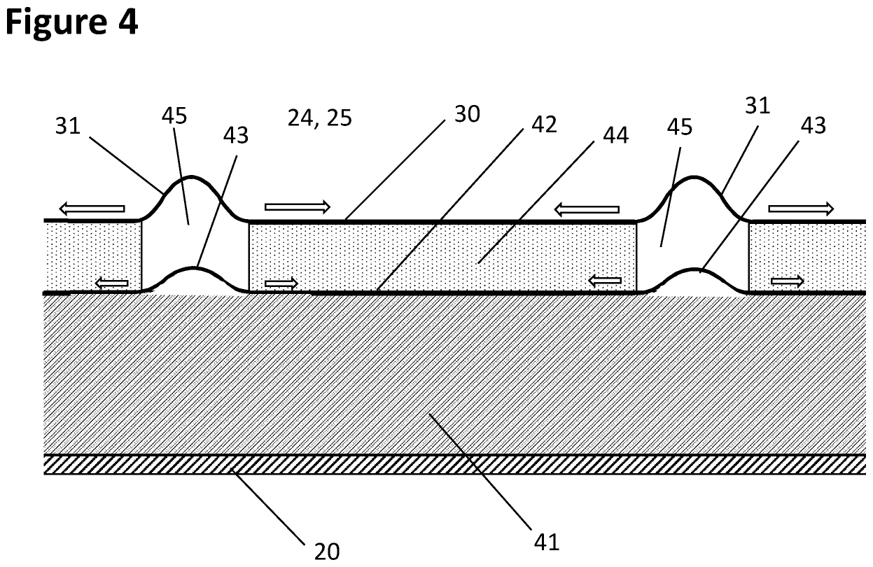

FIG. 4 illustrates how a layer of vacuum insulation may be implemented for the invention. The insulation system consists of two layers, a vacuum insulation layer 40 and an insulation layer with regular porous or fibrous type thermal insulation 41. These layers are separated by a leakage tight membrane 42 that ensures that air will not leak into the vacuum layer from outside. In case of storing liquid hydrogen in the tank the thickness of these layers should be balanced in such a way that the temperature in the second layer 41 next to the secondary membrane 42 is kept above the liquefaction temperature of air. For all applications use of vacuum insulation may be an effective and space saving way of achieving the desired thermal insulation properties. In all cases it is clear that the secondary membrane 42 will also be subject to substantial cooling and thereby undergo significant contraction. As for the primary membrane 30 it is important to avoid overstressing of the secondary membrane due to thermal contraction; this is easily dealt with by applying corrugations 43 that will bend and stretch when the membrane 42 is subjected to cooling. The corrugation geometry 31 provided by the invention, used for the primary membrane, can equally well be applied to the secondary membrane. The fact that the cooling and the thermal contraction will be somewhat less than for the primary membrane allows for using somewhat smaller amplitude of corrugation 43 of the secondary membrane. The space between the two membrane layers is subjected to pressure from the stored fluid as well as additional compression (suction) from the vacuum (about one atmosphere additional compression). The space between the two membrane layers must accordingly safely carry the resulting compression which is done with a porous or fibrous material 44 that has sufficient compressive stiffness and strength. This spacing material may include reinforcement systems with plate stiffening as mentioned earlier in connection with FIG. 3. FIG. 4 also indicates that there may be open spaces 45 between zones of supporting material as indicated by openings between the two layers of corrugations 31 and 43. These openings 45 provide a system of “canals” that span the entire vacuum enclosure around the inner tank 24, 25. This canal network is very useful for the process of efficient vacuuming of the space between the two membranes. Clearly, the supporting layer 44 must also be air evacuated via these canals 45.

As is easily understood, it is an alternative for the vacuum insulation layer to use insulation corrugation oriented as shown in FIG. 3b for the primary membrane rather than the corrugation oriented as shown in FIG. 3a and FIG. 4.

The present type of corrugated layer of vacuum insulation can also be used as effective means of thermal insulation for many more types of fluid storage than liquid hydrogen in a membrane tank of the invention.

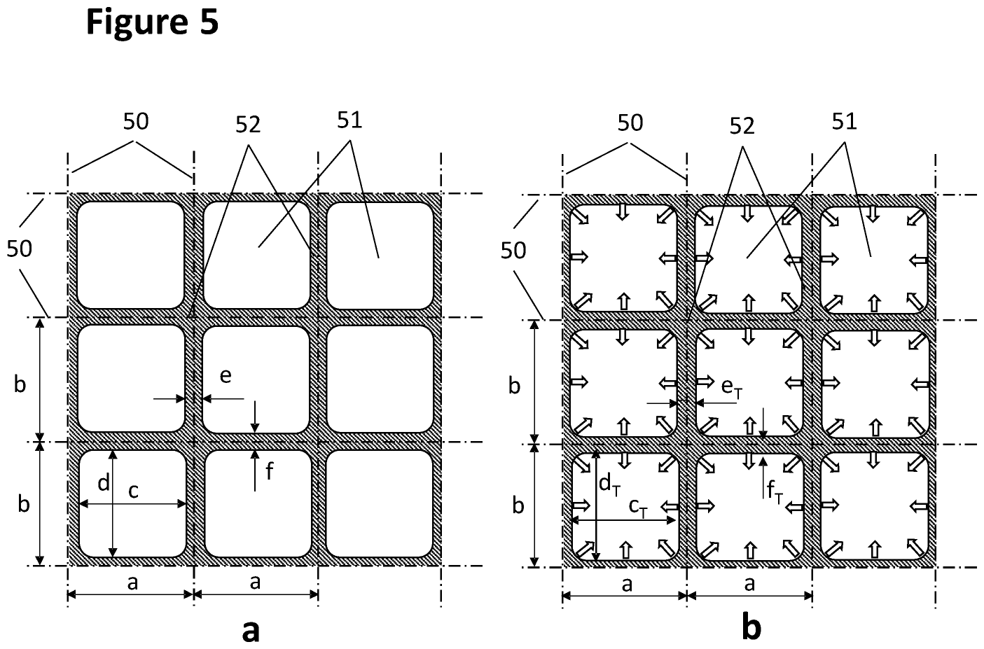

FIG. 5 illustrates in further detail how the invention works. FIG. 5a shows a section with a 3 by 3 pattern of membrane corrugations mounted before the tank has been filled with a cold fluid. Notably, a membrane tank of the invention works equally well for a hot fluid, but this is not repeatedly mentioned here because it will be understood that this simply means that thermal deformations will have the opposite sign of what is described in the following. Lines 50 indicate a pattern of system lines for the corrugations on the surface of the primary membrane before cooling takes place. The distance between the system lines is “a” in one direction and “b” in the other while in most instances the two distances will be the same. The figure also shows the smooth membrane areas 51 between corrugations and the shaded corrugation pattern 52 (inward or outward oriented) located between blocks before cooling. The smooth parts of the membrane 51 corresponds to 30 and the shaded zones 52 correspond to corrugation 31 in FIG. 3a with the difference that 51 also includes the intersections between crossing corrugations. The size of the contact areas between the membrane and the insulation support below are c in one direction and d in the other. The corrugations spans are accordingly e=a−c in one direction and f=b−d in the other before cooling.

FIG. 5b illustrates the situation after thermal cooling has taken place with internal, uniform, thermal contraction strain ET being the same in all directions for the membrane. This contraction is illustrated with arrows in the figure showing how the flat parts of the membrane contracts. Still the distances between system lines 50 on the primary are still in the same place since the membrane tank is fully locked by the fact that the membrane tank is constrained by the outer support structure 20, 21 which does not undergo cooling caused by cold fluid in the tank. Since the membrane contracts and the system lines do not move the thermal contraction must be compensated by bending and stretching of the flexible corrugations 52 while the smooth parts 51 shrink in accordance with the applied temperature change and thermal properties of the membrane material. The thermal strain ET and the actual contraction of the smooth parts of the membrane depend on the temperature change ΔT after cooling of the tank and the secant modulus (coefficient) of thermal expansion for the membrane a, thus

$${c}_{T} = c ( 1 + ε T ) = c ( 1 + αΔ T ) , and {d}_{T} = d ( 1 + αΔ T ) \qquad ( 1 )$$

Note that ΔT is negative for cooling considering −163° C. for liquefied natural gas and −253° C. for liquid hydrogen in relation to an initial temperature of 20° C. before cooling. The shrinking of the smooth sections between the corrugations means that the span of the corrugations will be stretched, thus

$${e}_{T} = a - {c}_{T} , and {f}_{T} = b - {d}_{T} \qquad ( 2 )$$

where the actual mechanical stretching of the corrugations is

$$Δ e = {e}_{T} - e = c - {c}_{T} = - c αΔ T , and Δ f = {f}_{T} - f = - d αΔ T \qquad ( 3 )$$

Note that negative ΔT gives positive values for the stretching Δe and Δf. This is shown as increased size of the corrugation zones in FIG. 5b. The thickness of the membrane and geometrical parameters such as a, b, c, d and the size and shape of the corrugations are chosen in accordance with the actual conditions of the specific application and requirements regarding acceptable deformational stresses and strains. Having larger distances, a and b, between corrugations means less corrugation, less welding, and cheaper solution. Numerical simulations show that distances between corrugations of more than 1 m are feasible with the current invention; this is significantly larger than common current membrane tank designs, such as for the corrugation shown in FIG. 1, for which up to about 0.2 m is typical.

As shown in FIG. 4 the secondary membrane 42, 43 can also be implemented as a corrugated membrane according to the invention. The primary insulation layer 44 may be of conventional thermal insulation or it may be vacuum insulation, depending on the embodiment of the invention. The temperature change ΔT of the secondary membrane will be less than for the primary membrane, and it will thus be subjected to less thermal contraction/expansion. The corrugation amplitude for the secondary membrane may thus be somewhat smaller than for the corrugation amplitude of the primary membrane.

The description hereto has referred to that thermal contraction will be dealt with by the flexibility of the corrugations. The objective is thus to establish a corrugation geometry with the best possible performance considering both plastic straining during fabrication and the combination of flexibility and minimum stresses being generated when it is stretched by cooling (or compressed by heating). A fundamental principle of mechanics states that a loaded, linearly elastic body will always deform in such way that the total (integral of) elastic energy accumulated during deformations will be at a minimum (the principle of minimum potential energy). Thus, a first step is to establish an initial geometry of the corrugation channels that represents a minimum potential energy geometry when the corrugation channels with span e and f, see of FIG. 5a, changes due to thermal deformations.

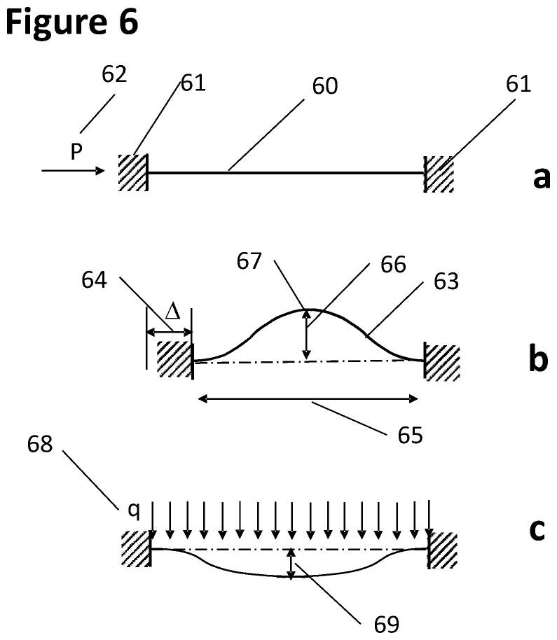

As will be known, a clamped beam or plate strip that is subjected to axial loading, or equivalently, to a forced end shortening, will buckle into a geometric shape that is defined exactly by a mathematical “cosine” function. This solution may be derived from beam equations using the principle of minimum potential energy for the stability problem. Hence, the cosine function represents the shape giving the smallest possible accumulation of stresses within a clamped beam or plate strip during buckling. Notably, the cosine function is also a preferred geometry for membrane corrugations since it also represents minimum energy condition for buckling or compression of a thin plate strip with width e and f. FIG. 6a shows a thin, elastic plate 60 with clamped sides 61 subjected to an end load 62. The clamped end condition corresponds to the transition to the flat membrane zone supported by the insulation layer.

FIG. 6b further shows correspondingly an elastic buckling shape 63 as result of the finite displacement Δ at end 64. Assuming small displacements, the buckling shape for both force loading 62 and forced displacement 64 is an exact cosine function. Although the cosine function applies only for infinitesimal deformations it can easily be scaled to any corrugation span 65 and amplitude 66 for the corrugation defined by its top point, “apex” 67. Numerical simulation studies have confirmed that scaled-up cosine functions work very well as definition of the initial corrugation geometry. Notably, the cosine shape provides very smooth curvature changes and moderate or minimal plastic strains during the plastic forming of the corrugation when fabricated. Going one step further, the principle of using buckling shapes for corrugations may easily be extended by utilizing more advanced buckling shapes accounting for nonlinear, large displacement effects. Rather than using simple cosine functions the preferred shape may thus be generated by computer simulations of plate buckling accounting for large displacement effects. Notably, such shapes have been shown to perform even better than small deformation cosine functions. Large displacement buckling shapes can also be scaled according to desired span 65 and amplitude 66 for the corrugations. Accordingly, FIG. 6b shows a geometry that may be said also to represent nonlinear theory buckling shapes for initial corrugation geometry.

FIG. 6c illustrates that generating corrugation shapes can also account for changes in geometry caused by lateral pressure q, see 68. In linear, elastic theory the deformed shape of a clamped beam subjected to uniform lateral pressure is given by a fourth order polynomial with max amplitude 69. In case of pure pressure in the tank without thermal deformation this would be a good choice for geometry of corrugations. However, for membrane tanks dominated by thermal straining the pressure effect on the corrugations is secondary and may be neglected. Depending on the actual thermal deformations versus pressure deformations it is also possible to augment the cosine buckling shape for the corrugation with a pressure polynomial according to the actual pressure. Similarly, using large displacement computer simulations shapes that account for both large displacement effects and correctly applied pressure loading it is thus possible to generate advanced deformational shapes 63 with desired amplitude 66 according to the method here described.

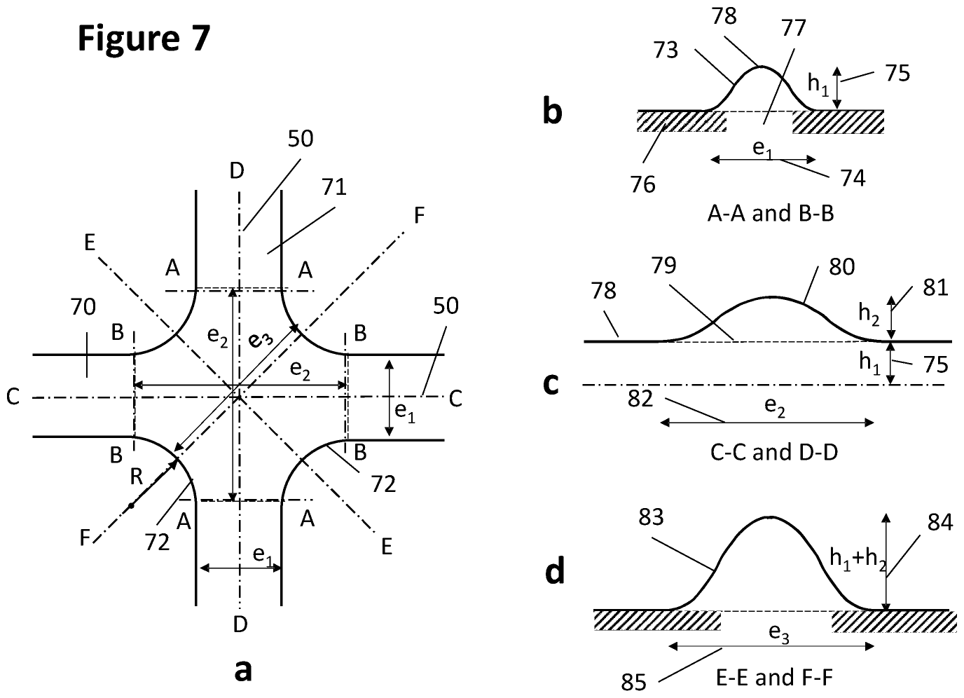

A particular challenge arises in that a simple extension of the geometries defined for the straight sections of the corrugation (“channels”) cannot be extended and applied without modifications to the crossing of corrugation channels shown in FIG. 5. The reason for this is that a continuous, straight apex line 67 going through the intersecting corrugations will completely “lock” against flexibility needed for compensating thermal deformations of the crossing corrugation at the intersection point of the apex lines, see lines 50 of FIG. 5. This problem is here solved by applying an extension of the method of using generated buckling shapes as earlier defined by the current invention. FIG. 7 shows the zone of intersection between two crossing corrugations 70 and 71.

Specifically, FIG. 7a shows two crossing corrugations with system lines 50 as also shown in FIG. 5. For simplicity, and as will be the case for most applications, the crossing corrugations in the figure have the same geometry with corrugation span e₁. The key to generating as low stresses as possible is to avoid stress concentrations and hard points, thus the border lines between the crossing corrugations and the flat zones should be rounded as indicated by 72, here shown as circular with curvature radius R.

Buckling shape geometry lines for the intersecting cosine-type corrugations are shown FIGS. 7b, 7c, and 7d. FIG. 7b illustrates the initial cosine or buckling type cross section geometry 73 of the corrugated membrane representing the straight part of the corrugations all the way up to their transition to the intersection zone marked with lines A-A and B-B in FIG. 7a. The figure shows the corrugation span e₁ marked 74, the initial corrugation height h₁ marked 75, and the underlying support from the primary insulation layer 76. The figure indicates that there can be a gap 77 between insulation blocks under the corrugation, the size of this gap is not significant provided it is smaller than e₁. 78 marks the apex line of the straight corrugation part positioned in accordance with the system lines 50.

FIGS. 7c and 7d illustrate further the intersection geometry according to the invention which prevents locking of the intersecting corrugations. Rather than directly continuing the straight corrugations with apex 78 according to line 79 through the intersection the crossing corrugations are augmented with an additional buckle with apex 80 and amplitude h₂ marked 81. The span of this additional buckle function is e₂ marked 82, also in FIG. 7a between transition lines A-A and B-B. The flexibility provided by this superimposed buckle with length e₂ enables the intersection to deform along the system lines 50 as well as diagonally as illustrated as a requirement in FIG. 5b.

A further definition of geometry of the intersection geometry is given in FIG. 7d showing the corrugation geometry 83 along diagonal sections E-E and F-F. The span of the diagonal section is e₃ marked 85 and the corrugation height 84 is the sum of h₁ and h₂. e₂ and e₃ are direct functions of the size of e₁ and R. The transitions between the corrugation intersection and the flat part of the membrane by the edge function 72 can alternatively be fitted with other geometries than circle sections. Examples of this are parabolic functions, hyper-ellipses, B-splines or other geometric functions that provide smooth and continuous corner functions marking the border to the corrugation.

The choice of parameters e₁, R, h₁ and h₂ implicitly defines the corrugation geometry along sections A-A, B-B, border line 72 with radius R, and sections C-C, D-D, E-E, F-F. The geometry of the buckle along can be chosen to be cosine function with span and amplitude in accordance with the chosen parameters. The smooth edge function 72 has outward normal slope equal to zero consistent with the flat or smooth part of the membrane. Based on these defined, characterizing buckling lines and boundary conditions, a complete, smooth buckle geometry can be defined using geometric surface fitting. Such smoothing techniques between specific geometric curves are widely used in numerical computer graphics. For instance, various B-spline type techniques including “nurbs” (non-uniform rational basis spline) are much used in computer generated surfaces and in animation movies.

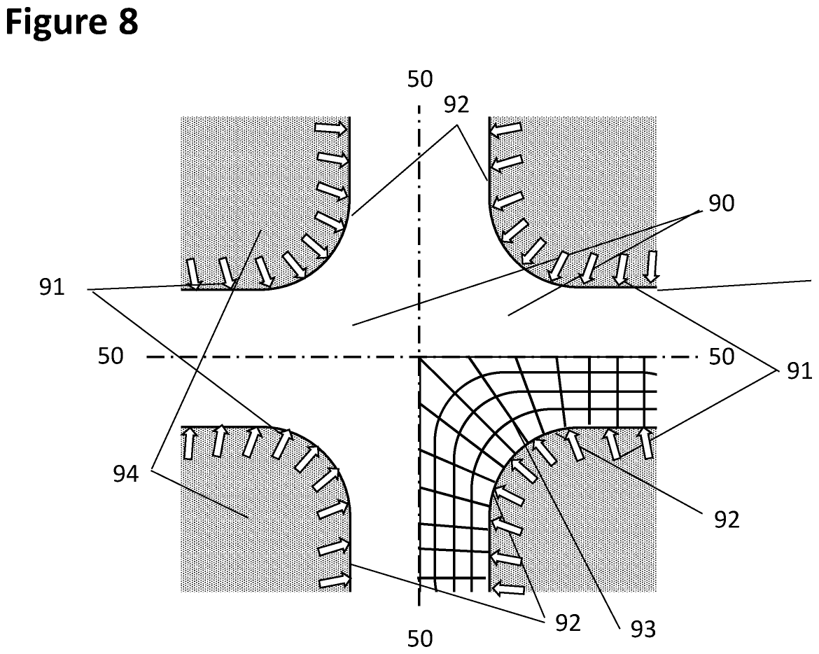

The concept of using a buckling function to define the corrugation geometry suggests an alternative approach whereby the buckle geometry is generated more directly by simulation of buckling of the corrugation intersection by use of nonlinear computational mechanics with large displacement effects. The basis for this is the membrane thermal contraction mechanism illustrated in FIG. 5b; however, the buckling phenomenon is generated by the inverse problem of thermal contraction which is thermal expansion. FIG. 8 shows an intersection part of membrane with an undeformed free span zone 90. The arrows 91 along the edges of the free span zone illustrate how these boundaries will move when the membrane is heated and the border lines 92 move accordingly. Note that these arrows are opposite to what is shown on FIG. 5. When the motion along the border lines 92 are sufficiently large, buckling of the free span zones will occur. This process can be simulated using computational mechanics by using, for example, the finite element method. The figure indicates a discretization mesh 93 for one quarter of the buckling field. For simplicity only a rather crude mesh is indicated in the figure. The smooth parts of the membrane 94 with the corrugation edge line 92 are constrained against buckling out of the plane. Further details about the computations are outside of the current scope; it should suffice to state that the computational model can include the entire field shown in the figure or, alternatively, a smaller one quarter model or an eight model by introduction of the appropriate boundary conditions along symmetry lines. The minimum energy buckling geometry can thus be established through numerical simulation by imposing appropriate displacement conditions around edges of the zone included in the computational model. The buckling computations can be linearized as an eigenvalue problem or be based on a fully nonlinear, large displacement formulation. The obtained buckle geometry can be scaled in the plane as well as in amplitude to arrive at a suitable corrugation geometry consistent with the main geometric parameters of the corrugated membrane. This geometry can thereby be applied for plastic forming of the corrugated membrane during fabrication. Although it might seem paradoxical, the buckling geometry generated by compression also represents a minimum energy form for contraction. The reason for this is that stresses from small deformations of the corrugated geometry are essentially the same with opposite sign when contraction (cooling) rather that compression is applied.

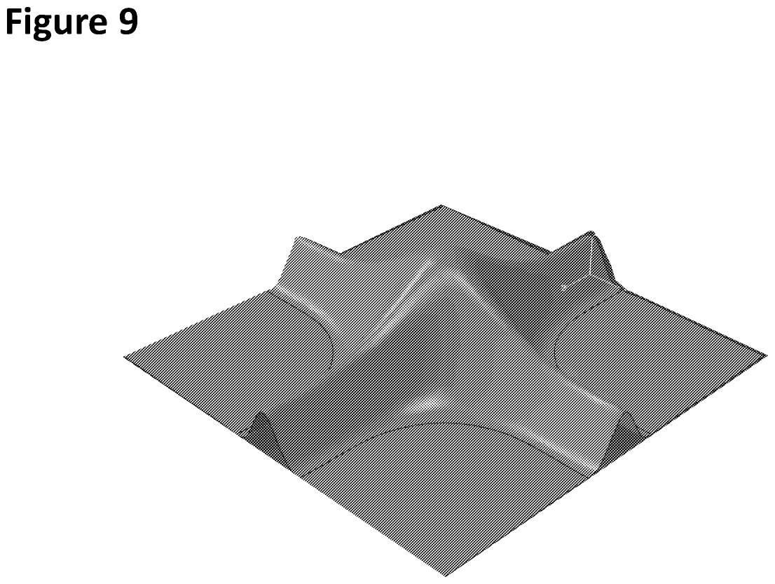

FIG. 9 shows a computer-generated plot of corrugation geometry generated according to the invention. Note that there are no sharp bends or folds, only smooth, transitional geometry. The geometry shown provides significant advantages over current membrane tank geometry as displayed in FIG. 1; this improved performance concerns both the magnitude of plastic strains created during forming of the corrugation as well as stresses and strains caused by thermal strains from major warming or cooling of the membrane. Computer simulations of membranes geometries have confirmed the very advantageous performance of corrugation geometries generated in accordance with the invention.

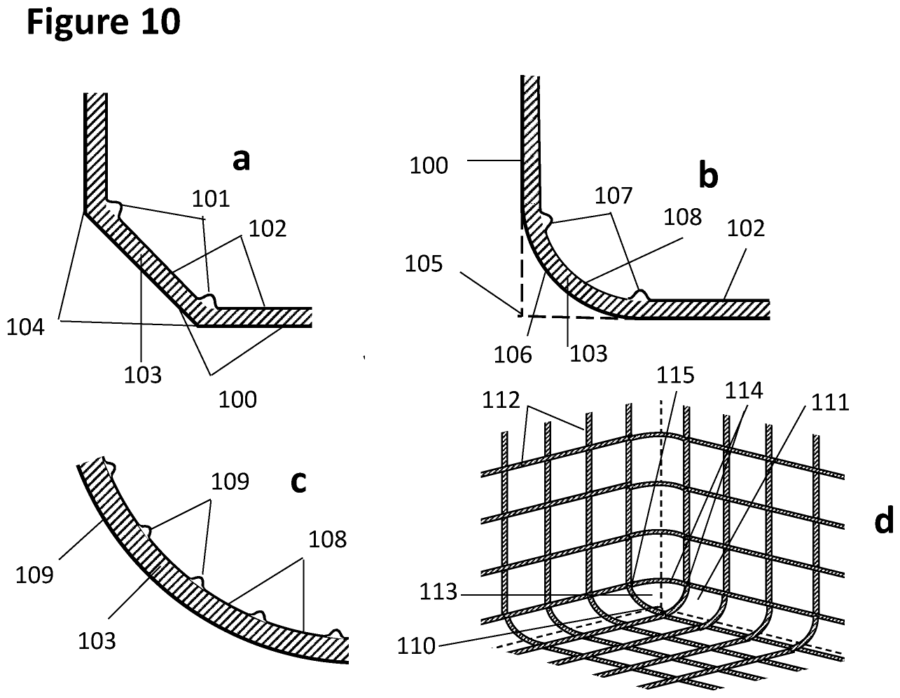

A thermally insulated membrane tank normally comprises a full enclosure with bottom, side walls, and top ceiling. This is illustrated for a typical ship cargo tank in FIG. 2 whereas many other tank geometries may also apply on ships, platforms and on land. The membrane geometry of the invention is easily extended to different tank geometries, for example considering transitions between different tank wall segments. FIG. 10 shows some examples of how the invention may be implemented for membrane tanks of different geometries. The illustrations are greatly simplified with focus on the corrugations for the primary membrane whereas other parts, such as primary insulation and secondary membrane and secondary insulation layer, are not shown. FIG. 10a illustrates an example with joining of flat planes for a supporting tank structure 100 with prismatic geometry. Corrugations 101 on the primary membrane 102 can be placed at the corners between joining planes. The insulation layers with secondary membranes are indicated in a simplified way by 103. This approach is suitable for oblique corner angles 104 (more than 90 degrees). Clearly, not shown here, there may be multiple corrugations on the planes 102 as well. FIG. 10b shows a case where the supporting structure 100 has a 90 degrees corner 105 for which corner corrugations may not be well suited. This problem can preferably be dealt with by rounding of the sharp corner by giving the supporting structure an augmented, rounded geometry 106 or, alternatively, filling out the corner area with insulation. Depending on the radius of curvature and suitable distance between corrugations there may be several corrugations 107 in the curved corner section 108 of the primary membrane. FIG. 10c shows an adaptation of the current corrugation system to cylindrical tanks. There are multiple corrugations 109 of the primary membrane around the entire cylindrical surface. Cylindrical tanks for LNG on land are often made of reinforced concrete combined with steel layers 109 while this is not shown in detail here. FIG. 10d corresponds to the prismatic tank of FIG. 10b with an illustration in 3-D perspective of a sharp prismatic tank corner 110 where the associated membrane tank corner 111 is rounded as is the insulation layer below. The shaded strips 112 indicate the overall corrugation system. The spherically shaped membrane corner zone 113 is surrounded by a triangular pattern of corrugations 114. Remarkably, the adjacent corner corrugations still cross each other at 90 degrees as indicated by 115.

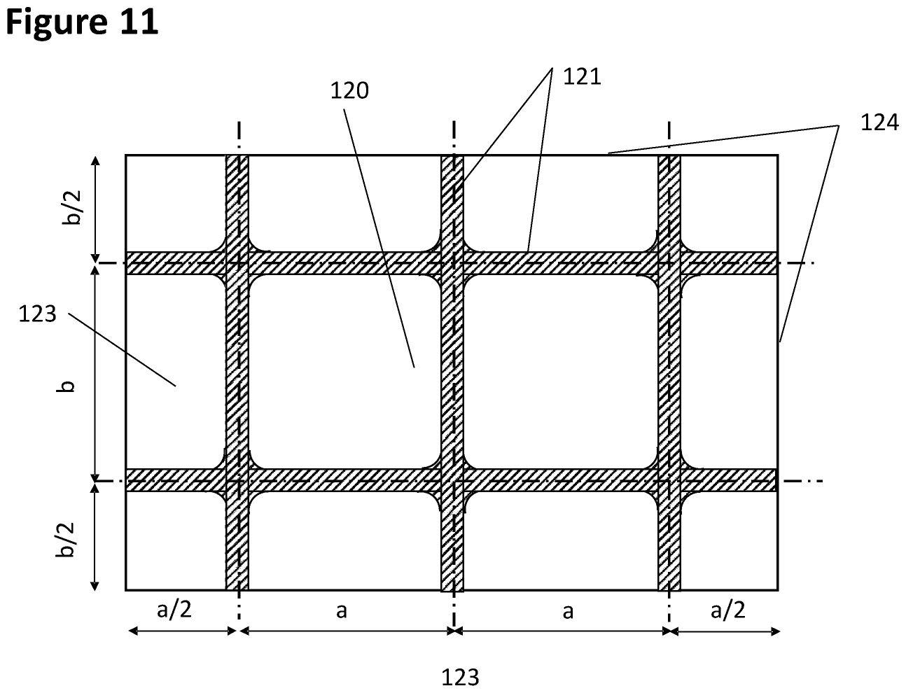

The membrane system lends itself easily to fabrication. Flat metal plates as shown in FIG. 11 can be pressed to desired corrugation geometry by use of press dies with the chosen, defined shape of corrugation geometry. A prefabricated membrane plate section 120 may include one or several corrugation units 121 depending on the size of the plate and the distance between corrugation system lines 122. FIG. 11 shows an example with 3 by 2 corrugation intersections. The outer parts of the plate 123 have width equal to half of the system line distance. In this way, the corrugated plate sections of the membrane may be joined along the rim 124, normally by welding, at the largest distance away from the corrugations. Depending on plate size and distance between corrugations there exist many alternatives for the pattern of corrugations within one fabricated plate, such as 1 by 1, 1 by 2, 2 by 2, 2 by 3, etc. The choice of size of the plate sections may also depend on the insulation system below the primary membrane such as whether there is a particular insulation unit size, e.g. insulation block or insulation box. The system for attachment of the primary membrane to the insulation layer below also depends on the properties of the insulation layer; such attachment may include adhesive and mechanical attachments.

Secondary membranes may also be fabricated using the corrugation system of the invention and by following a similar procedure as described for the primary membrane. The thermal deformations of secondary membranes will normally be smaller than for the primary membranes because of less thermal contraction due to the primary insulation layer. Considering also that there is no direct fluid pressure on the secondary membrane these factors may allow for smaller corrugation amplitudes than for the primary membrane. A special case is when the primary insulation layer is vacuumed to achieve better insulation properties. Vacuum within the primary insulation layer may enable the current membrane tank system to be used with fluids with temperatures far below the condensation temperature of dry air. One important such application may be for large volume, low pressure, liquid hydrogen tanks. Depending on the stiffness and strength of the primary as well as the secondary insulation layer such tanks may also be capable of sustaining a moderate pressure from inside the membrane tank.

### Further Remarks on Design, Principles and Implementation of the Invention

This invention deals with insulated membrane tanks holding fluids at low and cryogenic temperatures or, alternatively, holding fluid of very high temperatures. In principle, a membrane tank requires that the tank system includes an external, supporting structure capable of carrying the static and dynamic pressures from the fluid inside the tank. The invention focuses on a new type of membrane tank capable of dealing with major thermal deformations due to thermal significant difference in temperature between the fluid in the tank and the temperature of the external, supporting structure. This capability is achieved by use of a defined geometry for membrane corrugations based on utilization of geometries generated by use of buckling geometries associated with in-plane loading (or kinematic constraints) of beams and thin plates, and/or is achieved by having vacuum in at least the inner insulation layer. The geometry of the corrugations including their crossing can be based on specifically defined buckling functions known from the classical mechanics literature. Alternatively, and in many cases even better, the corrugation geometry can be derived following a specified procedure and by use of nonlinear computational mechanics.

Further, the invention concerns thermal insulation between the primary membrane of the tank and the external supporting structure. This insulation may consist of several layers, such as a primary and secondary layer, of insulation, as well as having a secondary membrane for leak prevention. For one main embodiment, the invention is not restricted to a particular type of thermal insulation but can be used along with most types of thermal insulation systems available today, including pebbles, fibers, and porous types of insulation, with or without strengthening systems or internal load carrying elements. For another main embodiment of the invention, at least the inner insulation layer is at vacuum when the so insulated tank is in operation during loading, containing, transporting and unloading of fluid, such as LH2. For demanding operations, such as for LH2 and preferably also LNG, the two main embodiments are preferably combined.

Whereas most current types of membrane tanks have secondary membranes that are straight without corrugations the invention opens for use of corrugated membrane of the type defined by the invention also for the secondary membrane. This enables a particular application whereby the primary insulation layer, also termed inner insulation layer or insulation, may be vacuumed with extremely low internal pressure. This provides a very efficient type of insulation with better insulation properties than most insulations that do not have vacuum. Another major advantage is that this opens for a particular embodiment of the invention whereby the tank can be used for liquefied gases with extremely low condensation temperature, such as liquid hydrogen and liquid helium.

The invention can be used for a huge variety of storage, cargo, and fuel membrane tanks, both with respect to geometry and size. Provided the external, supporting structure has sufficient strength the current modular, membrane corrugation system is fully scalable in size including tens of thousands of cubic meters. The membrane layer can be designed for significant internal tank pressures whereas, in most cases, the tank may be limited by the ability of the insulation layers to carry pressure.

The corrugated membranes of the invention can be made by use of plastic forming of metal plates, or by casting of a material suited for the purpose.

Fabricated plate units may contain a pattern of multiple corrugations. Plate units of the primary or secondary membranes may be joined together by welding or other types of joining techniques. The membranes may also be shaped to fit cylindrical tank surfaces and transitions between different tank planes such as for box-like or prismatic tank geometries.

The invention provides a membrane tank capable of storing fluids with temperature very much different from the external supporting structure. A particular feature is that the specific geometry of the corrugated membrane can sustain very large deformations caused by thermal contraction or thermal expansion while stresses are kept within acceptable level. This corrugation geometry has also major advantages with respect to minimizing plastic strains during forming of the corrugations. Some specific features of the invention can be summarized as follows:

1 The continuously smooth corrugations of the present invention results in larger distance between the crossing corrugations than the state-of-the-art corrugation. This means fewer corrugations per area, lowering the risk of failure and cost of fabrication. For example, assuming 1 m² membrane area, with one corrugation crossing in the center position, in a membrane of a membrane tank of the invention, then there is 1 crossing per m² membrane. For comparison, a state-of-the-art membrane with 0.5 m between corrugations will contain 4 corrugation crossings per m² membrane.
the membrane parts of the membrane tank of the invention can easily be fabricated by press die forming techniques, since corrugation crossings are monotonously tapered in shape, being conical and thereby not locking into a form with folds or “knots” 13 and 14 as illustrated for state-of the art corrugation crossings. Described otherwise, the inclination, from the flat, curved or double curved areas, to the top of crossing corrugations, always is significantly less than 90 degrees.
whereas the primary membrane contracts (or expands) significantly due to major difference in temperature between the fluid and the external supporting structure the membrane can absorb such deformations by bending and stretching of corrugations without any part of the membrane being overly stressed
plastic forming strains are significantly reduced
geometry of corrugations including intersections
any insulation system
connection between membrane and insulation layers of the primary and the secondary insulation layers
secondary membrane
vacuum insulation
tanks of any shape scalability
ease of fabrication
installation inside any outer structure, including caverns, in-ground tanks, free-standing tanks and as tanks integrated into ship hulls and bulkheads.
the corrugation shape of cosine function or a buckling function follows known formulas from textbooks, such as known polynomial equations or Taylor series, with accuracy within next in series part, and/or is determined by numerical simulations.
with corrugation of width e and f, where e is equal to or different from f, the corrugations must be high and wide enough to be stretched elastically Δ e or Δ f for cold or cryogenic service upon filling cold or cryogenic fluid and cooling down of the membrane. For warm fluid operation, the corrugations of width e and f must be high and wide enough to be compressed elastically Δ e or Δf. For membrane tanks of the invention for containing either cold/cryogenic or warm fluid, the corrugations of width e and f must be high and wide enough to be stretched or compressed elastically +Δ e or +Δ f.
can be used with different types of thermal insulation, such as insulation suitable for cryogenic or very warm fluids, including vacuum insulation.
A membrane tank of the invention for storing LH2 or helium, has the primary vacuum insulation layer and the secondary insulation layer which are sufficiently thick to avoid condensation of air.
The plastic forming process of the corrugations normally leaves significant residual stresses that can be reduced by applying stress relief methods and processing.

1. A membrane tank for containment of fluids at temperature that can differ significantly from ambient temperature, the membrane tank comprising, in direction from an inner containment volume:
a primary membrane that is fluid tight, facing the contained fluid in operation and functioning as the primary fluid barrier;
an insulation layer, surrounding the membrane on the outside;
an outer structure, such as a ship hull or bulkhead or other structure, wherein the outer structure supports the insulation layer and primary membrane inside and carries the resulting forces thereby; and
at least one opening for loading and unloading of fluid; and
an optional secondary membrane for added safety and prevention of leakage onto the outer structure such as a steel structure which could become brittle and thereby could fracture at cryogenic temperature, such as a ship hull outer structure, the secondary membrane dividing the insulation layer into an inner insulation between the primary and secondary membranes and an outer insulation between the secondary membrane and the outer structure;
wherein the primary membrane comprises areas of flat, curved or double curved shape and a corrugation in between the areas, wherein the areas are fastened to the underlaying insulation and the corrugations are taking up thermally induced strain,
wherein the membrane tank further comprises a coupling part for connecting a vacuum pump operatively to the whole insulation layer or the inner insulation layer, for enabling vacuum in the whole insulation layer or the inner insulation layer, during loading, containment and unloading of cryogenic fluid.

2. The membrane tank according to claim 1, wherein the corrugations have a shape, as seen in cross section, of a cosine function or a natural buckling function, resulting in that a minimum of elastic energy is stored in the corrugations by thermally induced contraction when cooling down the tank upon loading cryogenic fluid, resulting in only elastic stresses in the corrugations by the thermal contraction.

3. The membrane tank according to claim 1, wherein the actual stretching Δe and Δf upon cooling of the membrane by ΔT, with initial corrugation spans e and f at ambient temperature, wherein c and d are dimensions between the respective corrugations, are as follows:
$$Δ e = {e}_{T} - e = c - {c}_{T} = - c αΔ T , and Δ f = {f}_{T} - f = - d αΔ T \qquad ( 3 )$$
wherein α is the secant modulus (coefficient) of thermal expansion for the membrane.

4. The membrane tank according to claim 1, wherein the shape of crossing corrugations complies with a superimposed shape of the corrugations, without sharp bends or corners and without double folding, enabling simple die forming.

5. The membrane tank according to claim 1, further comprising an intermediate or secondary membrane that is fluid tight, dividing the insulation into two insulation layers, an inner insulation layer and an outer insulation layer, wherein the membranes are identical or different.

6. The membrane tank according to claim 5, wherein the coupling part for connecting a vacuum pump, and the vacuum pump, are arranged for providing vacuum in the inner-primary insulation layer and, if so required, also in the outer-secondary insulation layer, or the whole of a single insulation layer between primary membrane and outer structure, for enhanced insulation capacity and/or reduced insulation thickness.

7. The membrane tank according to claim 1, comprising membrane sections with corrugations, formed by die pressing or otherwise, with section sides at maximum distance from corrugation crossings, such as in or near centre of the section area, with section sides perpendicular to corrugations extending out through the sides.

8. Method A method of building a membrane tank according to claim 1, comprising the steps:
to build an insulation layer, wherein the insulation layer is arranged on an inner side of an outer structure, such as a ship hull or bulkhead or other loadbearing structure on land or at sea to surround the insulation on the outside;
to build or arrange at least one opening for loading and unloading of fluid;
to build and arrange a primary membrane that is fluid tight on the insulation surface, wherein the outer structure supports the inside insulation and primary membrane and carries the resulting forces thereby, and the membrane is containing for example a cryogenic fluid, wherein the membrane comprises areas of flat, curved or double curved shape, the areas are fastened to the underlaying insulation, the membrane further comprising a corrugation in between the areas for taking up thermally induced strain; and
wherein the method further comprises to arrange a coupling part for connecting a vacuum pump operatively to the insulation layer, for enabling vacuum in the insulation layer, between the primary membrane and the outer structure or between the primary membrane and an optional secondary membrane, during loading, containment and unloading of cryogenic fluid or other fluid.

9. The method according to claim 8, wherein the membrane is shaped with corrugations in between areas of flat, curved or double curved shape, the areas are fastened to the underlaying insulation, wherein the corrugations have a shape, as seen in cross section, of a cosine function or a buckling function, wherein a minimum of elastic energy is stored in the corrugations during forming as well as by thermally induced stretching of the corrugation when cooling down the tank upon loading cryogenic fluid, resulting in a minimum of stress in the corrugations by the stretching.

10. The method according to claim 8, wherein the primary membrane is formed as plate sections that are joined by welding or otherwise to complete the membrane, wherein crossing corrugations are at the centre and/or within the sides of the plate sections, such that plate sections are joined only at maximum distance from crossing corrugations, and the corrugations are preferably formed by plastic die pressing or similar pressing operations, preferably with sides perpendicular to corrugations extending out through the sides, wherein residual stresses from forming of the corrugations may be reduced by appropriate heat and stress relief treatment methods and, if required, geometric shape corrections, before welding or joining otherwise into a complete fluid tight membrane.

11. (canceled)

12. The membrane tank according to claim 1, wherein the fluids comprise a cryogenic fluid.
